(19) United States
(12) Patent Application Publication
(10) Pub. No.: US 2006/0208601 A1
(43) Pub. Date: Sep. 21, 2006

(54) Three phase claw pole type motor

(76) Inventors: Yuji Enomoto, Hitachi (JP); Kenji Miyata, Hitachinaka (JP); Yasuaki Motegi, Kiryu (JP); Kouki Isozaki, Kiryu (JP); Tadasi Sato, Kasagake (JP); Chio Ishihara, Tokyo (JP); Ryoso Masaki, Hitachi (JP); Motoya Ito, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/211,513

(22) Filed: Aug. 26, 2005

(30) Foreign Application Priority Data
Mar. 18, 2005 (JP) 2005-079282

(51) Int. Cl. H02K 1/12

(52) U.S. Cl. 310/257

(57) ABSTRACT

A three-phase claw-pole-type motor having claw poles easily manufacturable and having high efficiency. A plurality of claw poles are provided each of which has a claw portion, a radial yoke portion extending radially outwardly and perpendicularly from the claw portion, and an outer peripheral yoke extending from the radial yoke portion in the same direction as the direction of extension of the claw portion. A stator is constructed by interposing an annular coil between the craw poles. The claw poles are formed by compacting a magnetic powder of 2 teslas or higher.

### BACKGROUND OF THE INVENTION

The present invention relates to a three-phase claw-pole-type motor used in the fields of industry, home electric appliances, motor vehicles, etc., and, more particularly, to a three-phase claw-pole-type motor having an improved stator core.

### PRIOR ART

Claw pole type of iron cores are attracting attention which are provided in ordinary rotating electric motors for the purpose of improving the rate of use of magnetic fluxes efficiency by increasing a winding factor of windings, as disclosed in JP-A-2003-333777 for example.

In the conventional rotating electric motor having a claw pole type of iron core, claw poles of the iron core are formed by laminating a rolled plate and, therefore, can only be obtained in a simple shape. Therefore, the conventional rotating electric motor cannot be obtained as a desirable high-efficiency motor.

### SUMMARY OF THE INVENTION

An object of the present invention is to provide a three-phase claw-pole-type motor of high efficiency having claw poles easily manufacturable.

To achieve the above object, according to the present invention, there is provided a three phase claw pole type motor having a plurality of claw poles including a claw portion extending in an axial direction and having a magnetic pole surface facing a rotor in a state of being separated from the rotor by a small gap, a radial yoke portion extending radially outwardly from the claw portion, and an outer peripheral yoke extending from the radial yoke portion in the same direction as the direction of extension of the claw portion. The claw poles are alternately placed so that a distal end of each claw portion faces the radial yoke of an adjacent one of the claw poles to form a stator core. An annular core is interposed between each adjacent pair of the claw poles in the stator core to form a stator. The claw poles are formed by compression molding a magnetic powder of 2 teslas or higher.

The claw pole is formed by compacting a magnetic powder as described above. The claw pole can therefore be formed so as to have a complicated shape. Also, a high-efficiency motor can be obtained by using a magnetic powder with a magnetic flux density of 2 teslas or higher.

According to the present invention, as described above, a three-phase claw-pole-type motor having claw poles easily manufacturable and high-efficiency motor can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is an exploded perspective view of a first claw pole and a second claw pole used in a first embodiment of a three-phase claw-pole-type motor in accordance with the present invention;

FIG. 2 is a perspective view partly in section of stator cores for three phases obtained by assembling the first and second claw poles shown in FIG. 1;

FIG. 3 is a schematic longitudinal sectional view of the entire three-phase claw-pole-type motor in accordance with the present invention;

FIG. 4A is a sectional view taken along line A-A in FIG. 3;

FIG. 4B is a sectional view taken along line B-B in FIG. 3;

FIG. 4C is a sectional view taken along line C-C in FIG. 3;

FIG. 5 is a diagram showing magnetization characteristics of various core materials;

FIG. 6 is a diagram showing a mesh model of the core and the results of computation on the various core materials using three-dimensional magnetic field analysis;

FIG. 7A is a sectional view showing a main flux and a leakage flux in the claw pole;

FIG. 7B is a developed plan view showing a leakage flux in the claw pole;

FIG. 8 is a diagram showing the results of computation of the relationship between the shape of the claw portion of the claw pole and the effective value of the flux linkage using three-dimensional magnetic field analysis;

FIG. 9 is a perspective view partly in section of a second embodiment of the three-phase claw-pole-type motor in accordance with the present invention;

FIG. 10 is a sectional view partly in section of a third embodiment of the three-phase claw-pole-type motor in accordance with the present invention;

FIG. 11 is a perspective view partly in section of a fourth embodiment of the three-phase claw-pole-type motor in accordance with the present invention;

FIG. 12 is a sectional view partly in section showing the relationship between the magnetic poles and the claw poles in the embodiment shown in FIG. 11;

FIG. 13 is an exploded plan view showing an example of modification of the fourth embodiment;

FIG. 14 is an enlarged view partly in section of a fifth embodiment of the three-phase claw-pole-type motor in accordance with the present invention;

FIG. 15 is a perspective view of a sixth embodiment of the three-phase claw-pole-type motor in accordance with the present invention;

FIG. 16 is a perspective view of an example of modification of the sixth embodiment;

FIG. 17 is a perspective view of a claw iron core in a seventh embodiment of the three-phase claw-pole-type motor in accordance with the present invention;

FIG. 18 is a perspective view of an example of modification of the seventh embodiment;

FIG. 19 is a perspective view of an example of modification of the claw pole;

FIG. 20 is a perspective view of another example of modification of the claw pole; and

FIG. 21 is a perspective view of a further example of modification of the claw pole.

### PREFERRED EMBODIMENTS OF THE INVENTION

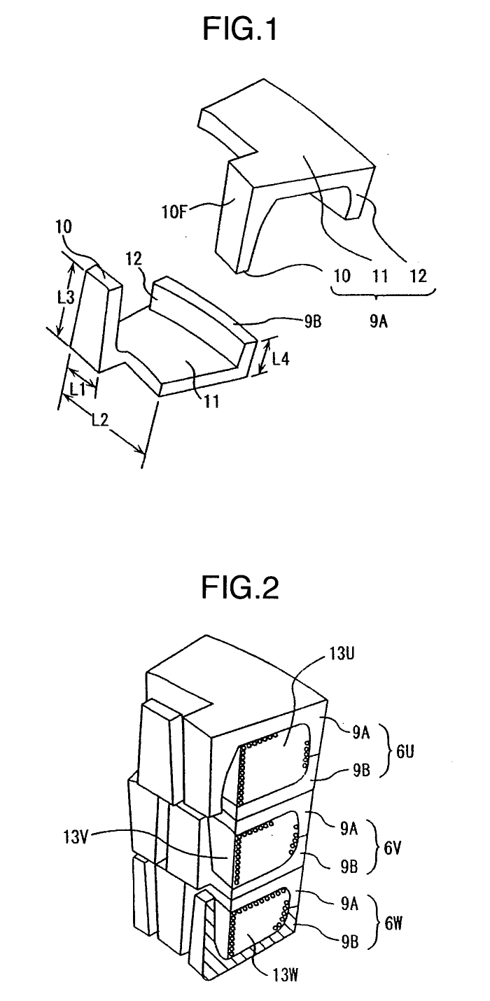

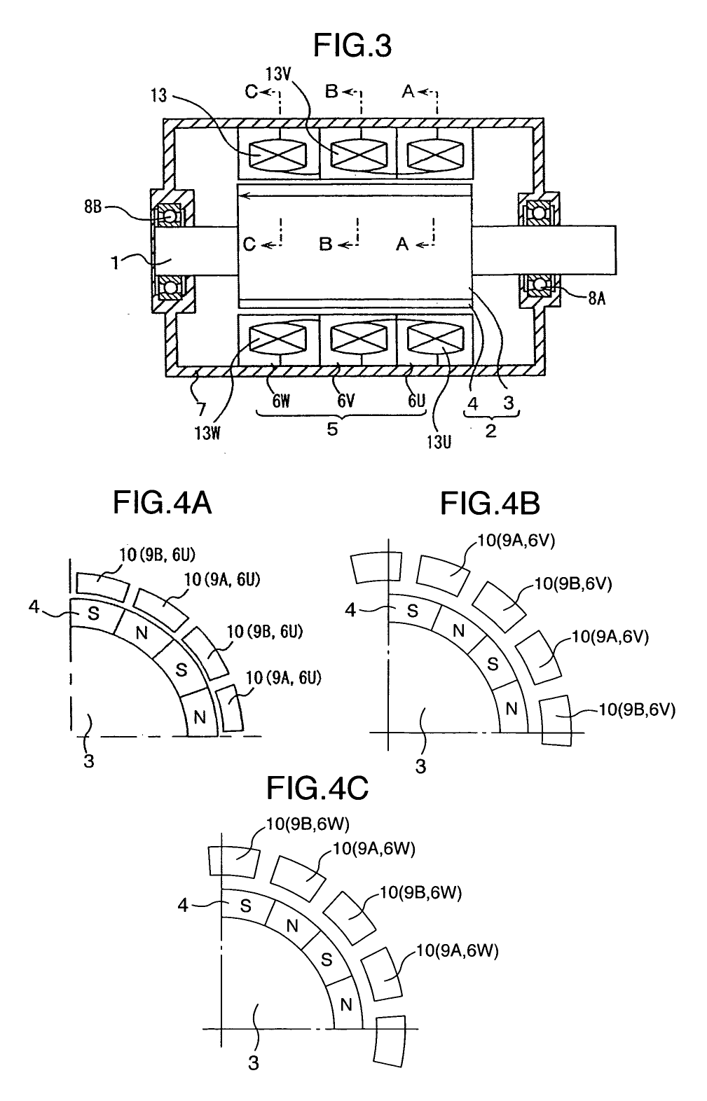

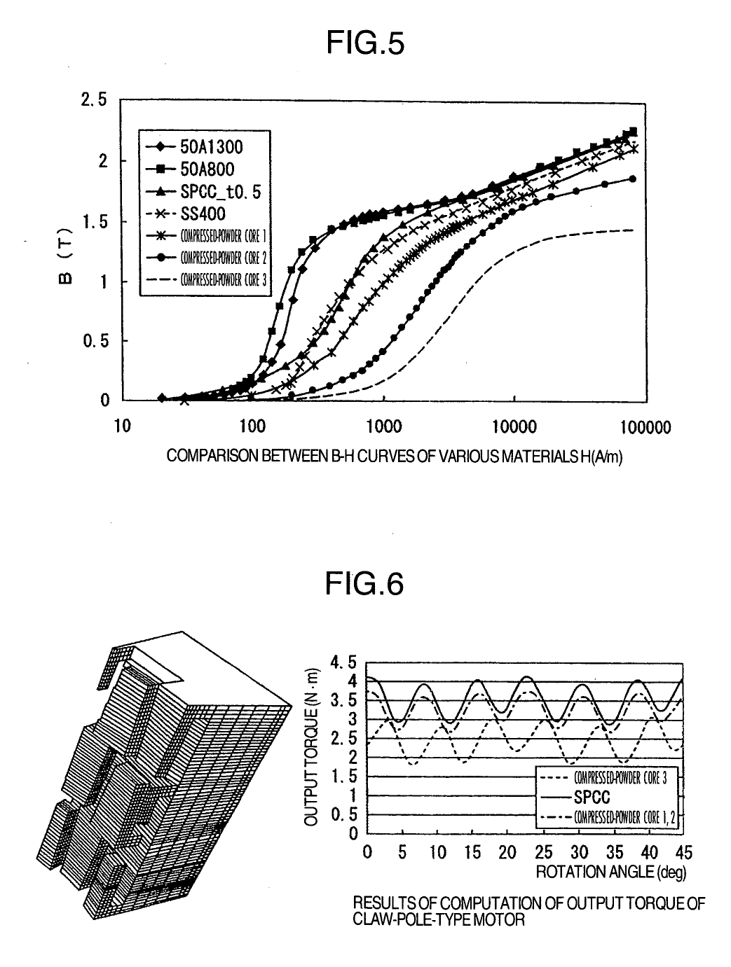

A first embodiment of the three-phase claw-pole-type motor in accordance with the present invention will be described with reference to FIGS. 1 to 4.

The three-phase claw-pole-type motor is constituted by a rotor 2 constructed on a rotating shaft 1, a stator 5 formed concentrically with the rotor 2 in a state of being separated from the rotor 2 by a small gap formed in the circumferential direction, and a stator frame 7 on which the stator 5 is supported. The rotating shaft 1 is rotatably supported on opposite ends of the stator frame 7 by bearings 8A and 8B.

The rotor 2 is constituted by a rotor core 3 formed concentrically with the rotating shaft 1, and a plurality of magnetic poles 4 formed of permanent magnets fixed on the outer periphery of the rotor core 3. The stator 5 is constituted by stator cores 6U, 6V, and 6W, and annular coils 13 wound on the stator cores 6U, 6V, and 6W. The stator cores 6U, 6V, and 6W are supported on the stator frame 7, and the rotating shaft 1 is rotatably supported by the bearings 8A and 8B on the opposite ends of the stator frame 7.

Each of the stator cores 6U, 6V, and 6W is constituted by a first claw pole 9A and a second claw pole 9B. Each of the first claw pole 9A and a second claw pole 9B is constituted by a claw portion 10 having a magnetic pole surface 10F extending in the axial direction and facing the rotor 2 while being separated from the same by the small gap, a radial yoke portion 11 extending radially outwardly and perpendicularly from the claw portion 10, and an outer peripheral yoke 12 extending from the radial yoke portion 11 in the same direction as the direction of extension of the claw portion 10. Each of the radial yoke portion 11 and the outer peripheral yoke 12 has a circumferential length L2 twice or longer than the circumferential length L1 of the claw portion 10. The claw portion 10 is connected to one side along the circumferential direction of the radial yoke portion 11 having the circumferential length L2. The outer peripheral yoke 12 has an axial length L4 of about 1/2 of the axial length L3 of the claw portion 10.

The first claw pole 9A and the second claw pole 9B are formed into shapes identical to each other by compacting a magnetic powder in a die. In this way, a complicated magnetic pole structure can be obtained in comparison with those constructed by laminating a silicon steel plate.

The first claw poles 9A and the second claw poles 9B formed as described above are alternately arranged in the circumferential direction so that the end of the claw portion 10 faces the inside diameter side of the radial yoke portion 11 of the adjacent claw pole 9A or 9B, thus forming the stator core 6U incorporating the annular coil 13U. The stator cores 6V and 6W incorporating the annular coils 13V and 13W are formed in this way and placed by the side of the stator core 6U in the axial direction with shifts of 120° in terms of electrical angle, as shown in FIGS. 4A to 4C, thus constructing the three-phase claw-pole-type motor having the same number of magnetic poles 4 as the number of claw portions 10, i.e., sixteen magnetic poles 4. These three groups of stator cores 6U, 6V, 6W are encapsulated in a molded insulating resin to obtain the stator 5 in which the first claw poles 9A, the second claw poles 9B and annular coils 13U, 13V, and 13W are combined integrally with each other.

As described above, a complicated magnetic pole construction, in other words a magnetic pole construction capable of improving the motor efficiency can be obtained by forming the first claw pole 9A and the second claw pole 9B by compacting a magnetic powder.

However, iron cores formed by compacting a magnetic powder (compressed-powder cores 1, 2, 3) ordinarily have a magnetic permeability lower than that of iron cores formed of a rolled plate (SPCC tO.5, SS400) and iron cores formed of a silicon steel plate (50A1300, 50A800). The maximum magnetic flux density of the former is also lower than that of the latter. Further, it has been found that, in use of iron cores formed by compression molding magnetic powders of 2 teslas or higher and perfectly identical in shape to each other (compressed-powder cores 1, 2, 3), as shown in the results of computation using three-dimensional magnetic field analysis on a mesh model shown in FIG. 6, the output torque (N•m) in the case of use of the compressed-powder core 3 having a maximum magnetic flux density lower than 1.5 teslas is lower by several percent to several ten percent than that in the case of use of the iron core formed of a rolled plate (SPCC tO.5), while the output torque (N•m) in the case of use of the compressed-powder core 1 or 2 having a maximum magnetic flux density equal to or higher than 1.5 teslas or exceeding 2 teslas is lower only by several percent than that in the case of use of the iron core formed of a rolled plate (SPCC tO.5).

In this embodiment, therefore, a magnetic powder of 2 teslas or higher is used to form the claw poles 9A and 9B by compacting. In this way, the claw poles 9A and 9B can be easily manufactured to obtain a high-efficiency three-phase claw-pole-type motor.

On the other hand, large torque pulsation occurs in the case of use of the iron core formed by compacting a magnetic powder, such that the magnitude of pulsation is 1/3 of the average torque. The cause of this torque pulsation is a large distortion in the waveforms of voltages induced in the annular coils 13U to 13W by local magnetic saturation in the claw poles 9A and 9B. Such a waveform distortion is also caused by an inter-pole leakage flux or an in-pole leakage flux.

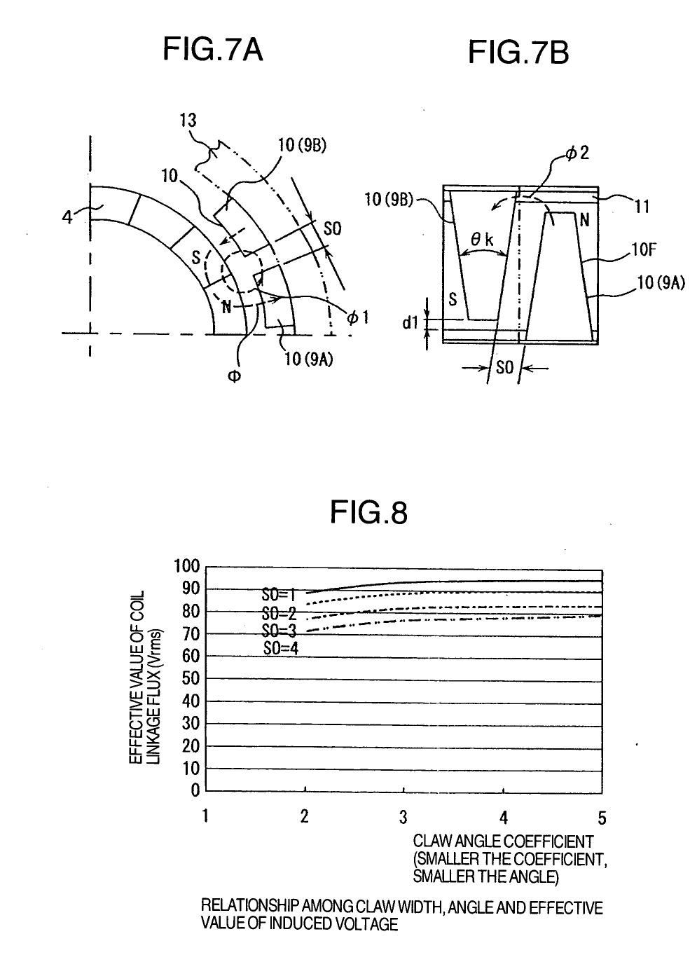

These leakage magnetic fluxes will be described with reference to FIGS. 7A and 7B. FIG. 7A shows the flow of a main flux Φ. The main flux Φemerging from one N-pole in the magnetic poles 4 for example enters the claw portion 10 of the first claw pole 9A through the gap, enters the claw portion 10 of the second claw pole 9B from the claw portion 10 of the first claw pole 9A in linkage to the annular coil 13, and enters the S magnetic pole 4 from the claw portion 10 of the second claw pole 9B through the gap, thus forming a magnetic path returning to the N magnetic pole 4. Apart from the main flux Φ, an inter-pole leakage flux φ exists. If the inter-pole size SO between the claw portions 10 of the first and second claw poles 9A and 9B is smaller than the gap size between the magnetic poles 4 and the claw portions 10, the inter-pole leakage flux φ forms a magnetic path by shortcutting between the claw portions 10 without linkage to the annular coil 13, resulting in a reduction in rate of use of the magnetomotive force of the magnetic poles 4 formed of permanent magnets. The inter-pole size SO between the claw portions 10 may be increased by considering this phenomenon. However, if the inter-pole size SO is increased, the width of the magnetic pole surface 10F is so small that the effective value of the flux linkage of linkage between the main flux Φ and the annular coil 13 is considerably reduced. It is not advisable to adopt such an easy way of increasing the inter-pole size SO.

Further, the generation of an in-pole leakage flux φ is a phenomenon in which, as shown in FIG. 7B, part of the main flux Φ entering the claw portion 10 of the first claw pole 9A enters the radial yoke portion 11 of the adjacent second claw pole 9B facing the first claw pole 9A from the distal end of the first claw pole 9A by forming the in-pole leakage flux φ2, and flows in the radial yoke portion 11 in the circumferential direction to form a magnetic path reaching the claw portion 10 of the second claw pole 9B. To reduce this in-pole leakage flux φ2, the sectional area of the distal end of the claw portion 10 may be reduced by increasing the angle θk of the magnetic pole surface 10F or the gap d1 between the distal end of the claw portion 10 and the radial yoke portion 11 may be increased. These measures to reduce the in-pole leakage flux φ2 entails the drawback of reducing the area of the magnetic pole surface 10F and thereby reducing the effective value of the flux linkage as in the above-described case. It is not advisable to adopt these measures.

FIG. 8 shows the results of computation of the relationship between the inter-pole size SO and the effective value of the flux linkage using the above-mentioned three-dimensional magnetic field analysis.

As is apparent from FIG. 8, the effective value of the flux linkage can be increased by increasing the angle Ok of the magnetic pole surface 10F and by reducing the inter-pole size SO of the adjacent claw portions 10. However, if the effective value of the flux linkage is increased, the leakage fluxes (φ1, φ2) are also increased to cause an increase in distortion of the waveform of the induced voltage, as described above.

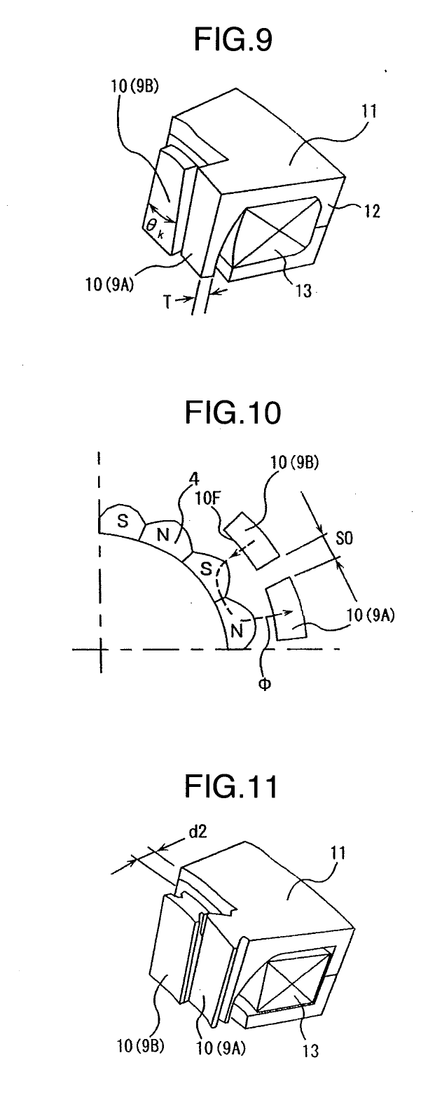

A second embodiment of the three-phase claw-pole-type motor in accordance with the present invention arranged to solve the above-described problem due to the leakage fluxes (φ1, φ2) and capable of maintaining a high effective value of the flux linkage will be described with reference to FIG. 9. In FIG. 9, the same reference characters as those in the figure showing the first embodiment indicate the same component parts. The description of the same component parts will not be repeated.

In this embodiment, the angle θk of the magnetic pole surface 10F is increased and the thickness T of the claw portion 10 is increased. Also, the thickness T is gradually increased along a direction from the distal end of the claw portion 10 toward the radial yoke portion 11.

If the sectional area of the claw portion 10 is increased as described above, a high effective value of the flux linkage can be maintained. Also, local magnetic saturation regions in the first and second claw poles 9A and 9B can be reduced. As a result, the leakage fluxes (φ1, φ2) are limited even if the inter-pole size SO is reduced by increasing the angle θk of the magnetic pole surface 10F. Therefore, distortion in the waveform of the induced voltage can be reduced and torque pulsation can be limited.

FIG. 10 shows a third embodiment of the three-phase claw-pole-type motor in accordance with the present invention. The third embodiment differs from the first embodiment in the sectional shape of the magnetic pole 4 on the rotor side.

That is, in this embodiment, the magnetic pole 4 is formed so as to have a sectional shape with a convex curve such that a central portion in the circumferential direction is closest to the claw portion 10 while opposite end portions in the circumferential direction are remotest from the claw portion 10.

If a curved surface defined by such a convex curve is formed on the magnetic pole 4, the main flux Φ can be made to flow intensively from a center of the curved surface into the claw portion 10. Also, the resistance of the magnetic flux path for the inter-pole leakage flux φ1 flowing in the claw portions 10 through the opposite end portions of the magnetic pole 4 in the circumferential direction as shown in FIG. 7A is increased by increasing the gap between the magnetic pole 4 and the claw portion 10, thereby reducing the amount of leakage of this flux. As a result, the inter-pole leakage flux φ1 can be reduced without reducing the effective value of the flux linkage.

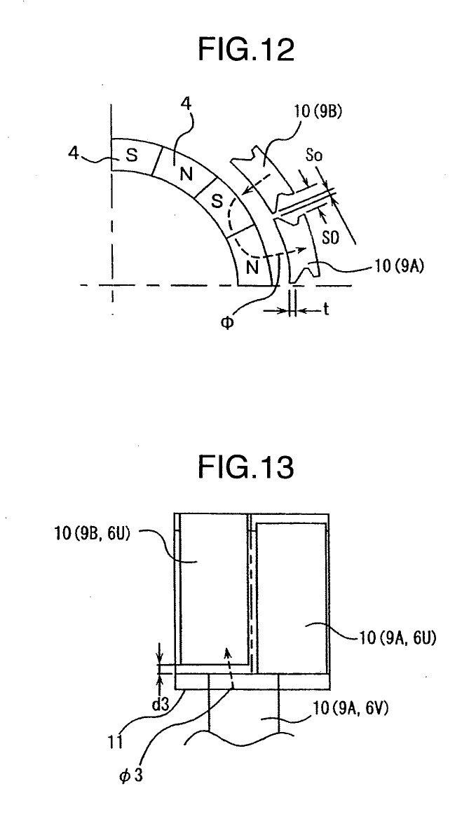

A fourth embodiment of the three-phase claw-pole-type motor in accordance with the present invention in which the shape of the claw portion 10 is changed to reduce a leakage flux will be described with reference to FIGS. 11 and 12.

The area of the magnetic pole surface 10F of the claw portion 10 facing the magnetic pole 4 is increased to ensure a high effective value of the flux linkage. The area of the magnetic pole surface 10F is increased by reducing the angle θk in the construction shown in FIG. 1 so that the sides defining the angle θk are parallel to the axial direction. Also, the inter-pole size SO between the claw portions 10 of each adjacent pair of the first and second claw poles 9A and 9B is increased relative to the gap between the claw portions 10 and the magnetic poles 4, but the inter-pole size So between portions of the claw portions 10 having a thickness t on the magnetic pole 4 side is reduced.

If the claw portions 10 are formed in this manner, the flow of the inter-pole leakage flux φ1 into the portions having the thickness t, between which the magnetic path between the claw portions 10 is restricted, is limited, thereby reducing the inter-pole leakage flux φ1.

To reduce the in-pole leakage flux φ2, the gap d2 between the distal end of the claw portion 10 and the radial yoke portion 11 of the adjacent claw pole 9A (or 9B) may be increased.

A leakage flux φ3 between adjacent pair of phases can be reduced, for example, by setting the gap d3 between the distal end of the claw portion 10 on the U-phase side and the radial yoke portion 11 of the adjacent claw pole 9A on the V-phase side to an increased value, as shown in FIG. 13.

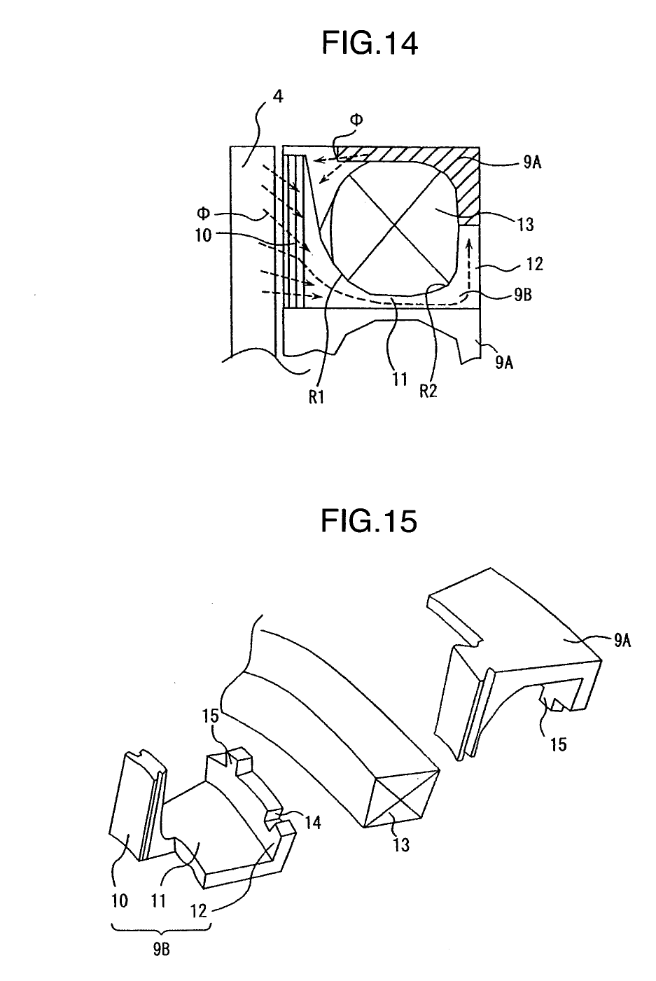

FIG. 14 shows a fifth embodiment of the three-phase claw-pole-type motor in accordance with the present invention.

In this embodiment, to enable the main flux Φ to flow through the shortest distance, concave portions R1 and R2 formed of polygonal surfaces are respectively formed as an inner corner portion in the connecting portion between the claw pole 9A or 9B and the radial yoke portion 11 and an inner corner portion in the connecting portion between the radial yoke portion 11 and the outer peripheral yoke 12. The concave portions R1 and R2 are formed by connecting a certain number of surfaces at certain angles. They may alternatively be formed of one curved surface or a certain number of curved surfaces.

A sixth embodiment of the three-phase claw-pole-type motor in accordance with the present invention will be described with reference to FIG. 15. The same basic construction for increasing the effective value of the flux linkage between the first claw pole 9A and the second claw pole 9B and reducing leakage fluxes as that in each of the above-described embodiments is also used in this embodiment. The description of the basic construction will not be repeated.

A three-dimensional shape of the first claw pole 9A and the second claw pole 9B can be integrally formed since the first claw pole 9A and the second claw pole 9B constituting each of stator cores 6U, 6V, and 6W are formed by compacting a magnetic powder, as described above. Since the first claw pole 9A and the second claw pole 9B are formed so as to be identical in shape to each other, it is desirable to attach marks used as a reference at the time of assembly to the first and second claw poles 9A and 9B. Further, it is advantageous to provide a function of a positioning member for positioning or assembling by forming the marks. Such a function is effective in improving the facility with which the component parts are assembled and reducing the assembly time.

To provide such a function in this embodiment, a recess 14 and a projection 15 capable of engaging with the recess 14 are formed in the outer peripheral yoke 12 constituting the first claw pole 9A and the second claw pole 9B. Recesses 14 and projections 15 are formed in the first and second claw poles 9A and 9B by being recessed and raised along the axial direction so as to be capable of fitting to each other when the first and second claw poles 9A and 9B are brought into abutment on each other. The recessed groove 14 and the projection 15 are formed at positions distanced by 180° in terms of electrical angle in the circumferential direction. Since the first and second claw poles 9A and 9B are perfectly identical in shape to each other, they can be compacted in one mold.

When the first and second claw poles 9A and 9B constructed as described above are assembled, they are fitted to each other by simply moving the projections 15 into the recesses 14 in the axial direction, with the annular coil 13 interposed between the claw portions 10 and the radial yoke portions 11. Thus, the assembly can be easily completed.

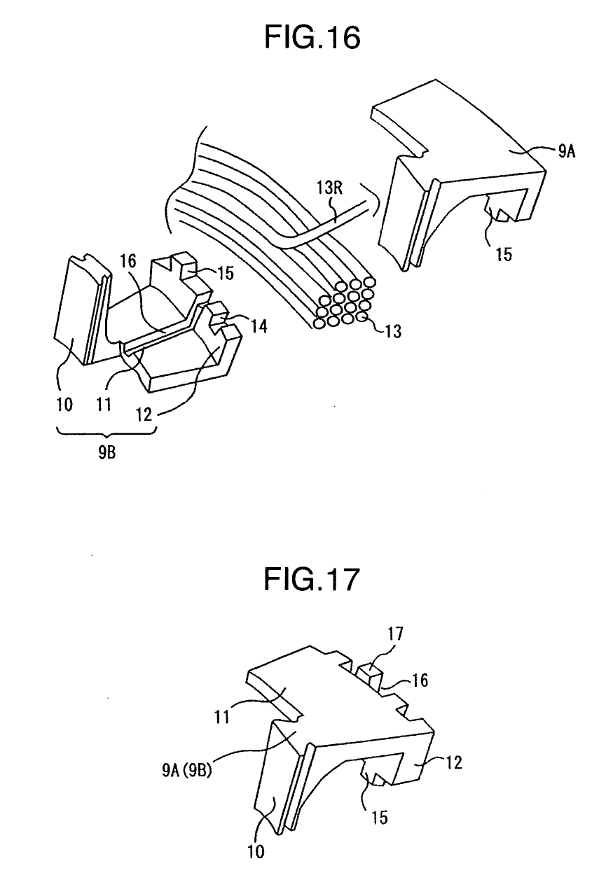

FIG. 16 shows an example of modification of the sixth embodiment. A lead wire channel 16 through which a lead wire 13R corresponding to a winding-leading end and/or a wiring-trailing end of the annular coils 13 is laid to the outside is formed by integral molding in each of the surfaces of the radial yoke portions 11 of the first and second claw poles 9A and 9B facing the annular coil 13.

If the lead wire channel 16 is formed in the radial yoke portion 11 in advance, the need for provision of an additional space for the lead wire 13R is eliminated, thereby increasing the winding density of the annular coil 13 and enabling lead wires 13R in the entire motor to be laid in a determined direction.

While the facility with which the first and second claw poles 9A and 9B in the in-phase relationship are assembled is improved in the above-described sixth embodiment, an improvement in the facility with which the first and second claw poles 9A and 9B in an interphase relationship are assembled can be achieved in a seventh embodiment shown in FIG. 17.

That is, a recess 16 and a projection 17 are formed on the radial yoke portion 11 side in the outer peripheral yokes 12 of the first and second claw poles 9A and 9B in an interphase relationship by being placed side by side in the axial direction, in addition to the recess 14 and the projection 15 shown in FIG. 15. Recesses 16 each capable of being fitted to one projection 17 provided at least in one place are formed at positions distanced by ±60° and ±120° in terms of electrical angle from the position of the projection 17, thereby enabling the outer peripheral yokes 12 of the first and second claw poles 9A and 9B in an interphase relationship to be positioned relative to each other with accuracy as well as facilitating the assembly.

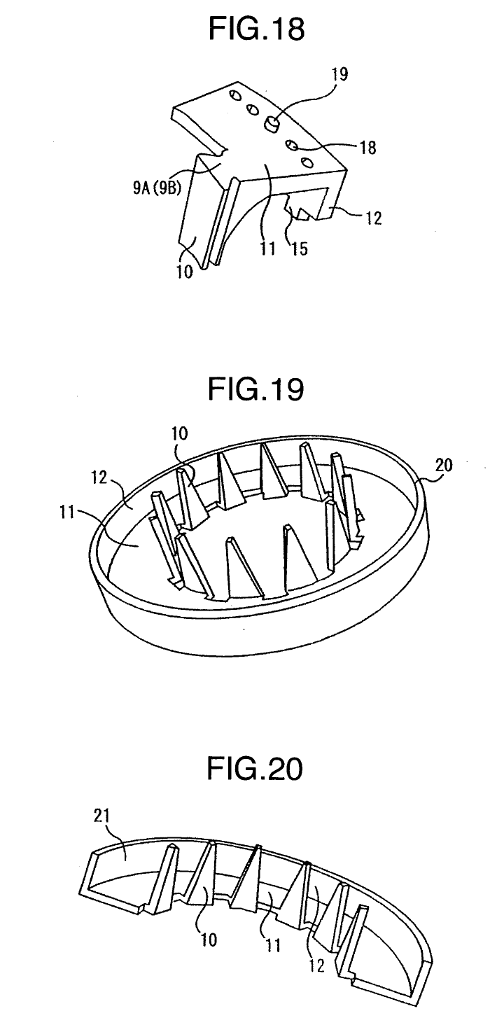

FIG. 18 shows an example of modification of the seventh embodiment. Fitting holes 18 and a fitting projection 19 arranged in the axial direction are formed in the outer peripheral yokes 12 of the first and second claw poles 9A and 9B in an interphase relationship, as are the projection and the recesses in the seventh embodiment. Also in this case, the same effect as that in the seventh embodiment is achieved.

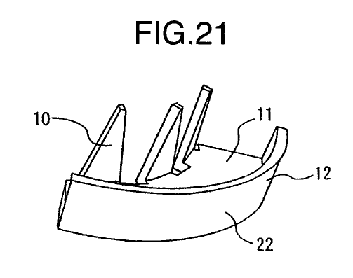

In each of the above-described embodiments, the first and second claw poles 9A and 9B are formed in correspondence with each pole. However, needless to say, a claw pole assembly 20 in which claw pole portions for one phase (360°) are formed integrally with each other as shown in FIG. 19, a claw pole assembly 21 in which claw pole portions for 1/2 phase (180°) are formed integrally with each other as shown in FIG. 20 and a claw pole assembly 22 in which claw pole portions for 1/4 phase (90°) are formed integrally with each other as shown in FIG. 21 may be formed. In such case, the relationship between the positions at which the recesses 14 or 16 and the projections 15 or 17 are provided and the relationship between the positions at which the fitting holes 18 and the fitting projections 19 are provided may be angular relationships of integer multiples of ±60° and ±120° in terms of electrical angle.

It should be further understood by those skilled in the art that although the foregoing description has been made on embodiments of the invention, the invention is not limited thereto and various changes and modifications may be made without departing from the spirit of the invention and the scope of the appended claims.

1. A three phase claw pole type motor comprising:
a plurality of claw poles including a claw portion extending in an axial direction and having a magnetic pole surface facing a rotor in a state of being separated from the rotor by a small gap, a radial yoke portion extending radially outward1y from the claw portion, and an outer peripheral yoke extending from the radial yoke portion in the same direction as the direction of extension of the claw portion;
the claw poles being alternately placed so that a distal end of each claw portion faces the radial yoke of an adjacent one of the claw poles to form a stator core;
an annular core interposed between each adjacent pair of the claw poles in the stator core to form a stator; and
the claw poles being formed by compacting a magnetic powder of 2 teslas or higher.

2. The three phase claw pole type motor according to claim 1, wherein the claw poles are formed into shapes identical to each other.

3. The three phase claw pole type motor according to claim 1, wherein the claw portion is formed so that its thickness increases gradually along a direction from the distal end toward the radial yoke portion.

4. The three phase claw pole type motor according to claim 1, wherein each of an inner corner portion in a connecting portion between the claw portion and the radial yoke portion of the claw pole and an inner corner portion in a connecting portion between the radial yoke portion and the outer peripheral yoke is formed into a concave shape formed of a polygonal surface.

5. The three phase claw pole type motor according to claim 1, wherein a portion of each claw pole facing an adjacent one of the claw poles is parallel to the axial direction.

6. The three phase claw pole type motor according to claim 1, wherein the plurality of claw poles is encapsulated in a molded resin to be combined integrally with each other.

7. A three phase claw pole type motor comprising:
a plurality of claw poles including a claw portion extending in an axial direction and having a magnetic pole surface facing a rotor in a state of being separated from the rotor by a small gap, a radial yoke portion extending radially outwardly from the claw portion, and an outer peripheral yoke extending from the radial yoke portion in the same direction as the direction of extension of the claw portion;
the claw poles being alternately placed so that a distal end of each claw portion faces the radial yoke of an adjacent one of the claw poles to form a stator core;
an annular core interposed between each adjacent pair of the claw poles in the stator core to form a stator; and
the claw poles being formed by compacting a magnetic powder of 2 teslas or higher, each claw pole having a positioning engagement portion in a portion facing an adjacent one of the claw poles.

8. The three phase claw pole type motor according to claim 7, wherein the claw poles are formed into shapes identical to each other.

9. The three phase claw pole type motor according to claim 7, wherein the claw portion is formed so that its thickness increases gradually along a direction from the distal end toward the radial yoke portion.

10. The three phase claw pole type motor according to claim 7, wherein each of an inner corner portion in a connecting portion between the claw portion and the radial yoke portion of the claw pole and an inner corner portion in a connecting portion between the radial yoke portion and the outer peripheral yoke is formed into a concave shape formed of a polygonal surface.

11. A three phase claw pole type motor according to claim 7, wherein a portion of each claw pole facing the adjacent claw pole is parallel to the axial direction.

12. A three phase claw pole type motor according to claim 7, wherein the plurality of claw poles is encapsulated in a molded resin to be combined integrally with each other.

13. A three phase claw pole type motor comprising:
a plurality of claw poles including a claw portion extending in an axial direction and having a magnetic pole surface facing a rotor in a state of being separated from the rotor by a small gap, a radial yoke portion extending outer peripheral outwardly from the claw portion, and an radial yoke portion yoke extending from the radial yoke portion in the same direction as the direction of extension of the claw portion;
the claw poles being alternately placed so that a distal end of each claw portion faces the radial yoke of an adjacent one of the claw poles to form a stator core;
an annular core interposed between each adjacent pair of the claw poles in the stator core to form a stator; and
the rotor having a plurality of permanent magnets arranged in a circumferential direction and facing the magnetic surfaces of the claw poles, each permanent magnet being formed so that the gap between the permanent magnet and the magnetic surface is reduced at a center and increased at opposite ends in the circumferential direction, the claw poles being formed by compacting a magnetic powder of 2 teslas or higher.

14. The three phase claw pole type motor according to claim 13, wherein the claw poles are formed into shapes identical to each other.

15. The three phase claw pole type motor according to claim 13, wherein the claw portion is formed so that its thickness increases gradually along a direction from the distal end toward the radial yoke portion.

16. The three phase claw pole type motor according to claim 13, wherein each of an inner corner portion in a connecting portion between the claw portion and the radial yoke portion of the claw pole and an inner corner portion in a connecting portion between the radial yoke portion and the outer peripheral yoke is formed into a concave shape formed of a polygonal surface.

17. The three phase claw pole type motor according to claim 13, wherein a portion of each claw pole facing the adjacent claw pole is parallel to the axial direction.

18. The three phase claw pole type motor according to claim 13, wherein the plurality of claw poles is encapsulated in a molded resin to be combined integrally with each other.
